(19) United States
(12) Patent Application Publication
(10) Pub. No.: US 2022/0288729 A1
(43) Pub. Date: Sep. 15, 2022

(54) MANUFACTURING PROCESS FOR HEAT EXCHANGERS

(71) Applicants: DENSO International America, Inc., Southfield, MI (US); Denso Corporation, Kariya (JP)

(72) Inventor: Steven Maloney, Novi, MI (US)

(21) Appl. No.: 17/199,781

(22) Filed: Mar. 12, 2021

(51) Int. Cl. B23P 15/26; F28F 9/02

(52) U.S. Cl. CPC B23P 15/26; F28F 9/0246

(57) ABSTRACT

A method for manufacturing heat exchangers includes securing a plurality of tubes to first and second header plates such that each tube extends between the first and second header plates and such that each tube is spaced apart from adjacent tubes; disposing a portion of the plurality of fins between adjacent tubes of the plurality of tubes other than a preselected pair adjacent tubes of the plurality of tubes; disposing a spacer between the tubes of the preselected pair adjacent tubes; heating the first and second header plates, the plurality of tubes, the plurality of fins, and the spacer in a brazing furnace such that a brazing material joins the plurality of fins to the plurality of tubes; and dividing each of the first and second header plates between the tubes of the preselected pair of adjacent tubes to form two heat exchangers.

### TECHNICAL FIELD

The present disclosure relates to a manufacturing process for heat exchangers, particularly to tube and fin type heat exchangers.

### BACKGROUND

Tube and fin heat exchangers may be utilized to transfer heat between a fluid flowing through the tubes of the heat exchanger and air that is being direct across the fins of the heat exchanger.

### SUMMARY

A method for manufacturing heat exchangers includes coating at least one of a plurality of fins and a plurality of tubes with a brazing material; disposing the plurality of tubes between first and second header plates such that each tube extends into one of a plurality of orifices defined by the first header plate at a first end and such that each tube extends into one of a plurality of orifices defined by the second header plate at a second end; disposing a portion of the plurality of fins between adjacent tubes of the plurality of tubes other than one or more pairs of preselected adjacent tubes of the plurality of tubes; disposing a spacer between the tubes in each pair of the one or more pairs of preselected adjacent tubes; placing the first and second header plates, the plurality of tubes, the plurality of fins, and the spacer into a brazing furnace; heating the first and second header plates, the plurality of tubes, the plurality of fins, and the spacer in the brazing furnace such that the brazing material joins the plurality of fins to the plurality of tubes; and dividing each of the first and second header plates between the tubes of each pair of the one or more pairs of preselected adjacent tubes to form a plurality of heat exchangers.

A method for manufacturing heat exchangers includes securing a plurality of tubes to first and second header plates such that each tube extends between the first and second header plates and such that each tube is spaced apart from adjacent tubes; disposing a portion of the plurality of fins between adjacent tubes of the plurality of tubes other than a preselected pair adjacent tubes of the plurality of tubes; disposing a spacer between the tubes of the preselected pair adjacent tubes; heating the first and second header plates, the plurality of tubes, the plurality of fins, and the spacer in a brazing furnace such that a brazing material joins the plurality of fins to the plurality of tubes; and dividing each of the first and second header plates between the tubes of the preselected pair of adjacent tubes to form two heat exchangers.

A method for manufacturing heat exchangers includes securing first and second header plates, a plurality of tubes, and a plurality of fins to a fixture such that each tube is spaced apart from adjacent tubes, and such that a portion of the plurality of fins is disposed within spaces defined between adjacent tubes other than a preselected pair adjacent tubes of the plurality of tubes; disposing a spacer between the tubes of the preselected pair adjacent tubes; heating the first and second header plates, the plurality of tubes, the plurality of fins, and the spacer in a brazing furnace such that a brazing material joins the plurality of fins to the plurality of tubes; and dividing each of the first and second header plates along the space defined between the tubes of the preselected pair of adjacent tubes to form a pair of heat exchangers.

### BRIEF DESCRIPTION OF THE DRAWINGS

FIG. 1 is a front view of a heat exchanger;

FIG. 2 is a perspective view of a header of the heat exchanger;

FIG. 3 is a flowchart of a method for manufacturing a plurality of heat exchangers;

FIG. 4 is a front view of an array of tubes and fins along with two header plates that may be utilized to manufacture the plurality of heat exchangers according to the method of FIG. 3;

FIG. 5 is a front view of the area A in FIG. 4 illustrating a first spacing system that may be utilized according to the method of FIG. 3;

FIG. 6 is a front view of the area A in FIG. 4 illustrating a second spacing system that may be utilized according to the method of FIG. 3;

FIG. 7 is a front view of the area A in FIG. 4 illustrating a third spacing system that may be utilized according to the method of FIG. 3; and

FIG. 8 is a bottom view of a portion of the array of tubes and fins along with the two header plates illustrated in FIG. 4, and a fourth spacing system that may be utilized according to the method of FIG. 3.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

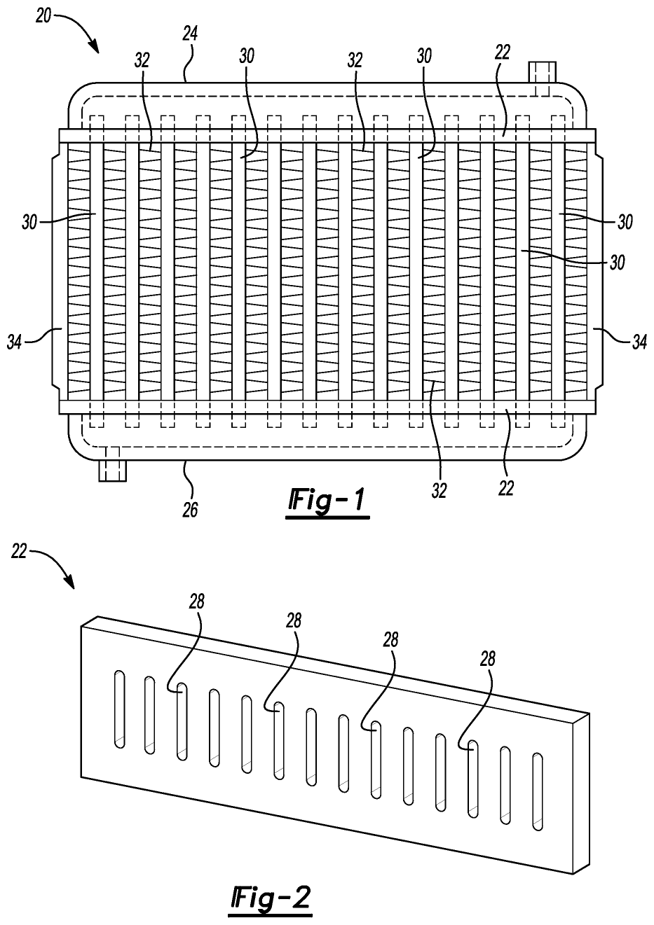

Referring to FIGS. 1 and 2, a heat exchanger 20 and a header 22 of the heat exchanger 20 are illustrated, respectively. Please note that FIGS. 1 and 2 are simplified drawings and the respective components described in FIGS. 1 and 2 may have additional features or different geometry than is illustrated in FIGS. 1 and 2. The heat exchanger 20 includes a first header tank 24 and a second header tank 26. A first header 22 is secured to the first header tank 24 and a second header 22 is secured to the second header tank 26. The headers 22 may also be referred to as header plates.

Each header 22 defines a plurality of orifices 28. A plurality of tubes 30 extend between the first header tank 24 and the second header tank 26. More specifically, a first end of each of the tubes 30 extends into a respective one of the plurality of orifices 28 of the first header 22 while a second end of each of the tubes 30 extends into a respective one of the plurality of orifices 28 of the second header 22. Each of the plurality of tubes 30 may extend into and may be secured to the headers 22 by brazing each tube 30 to the headers 22 proximate the respective orifices 28 that the first and second ends of the tubes 30 extend into. The plurality of tubes 30 are configured to channel a coolant, a refrigerant, or any other heat exchanging liquid or gas from the first header tank 24 to the second header tank 26. Coils or fins 32 are disposed between adjacent tubes 30 forming an array of alternating tubes 30 and fins 32. The fins 32 facilitate heat transfer between the liquid or gas that is flowing through the plurality of tubes 30 and air that is being directed across the heat exchanger 20.

A pair of side plates 34 may be disposed on opposing ends of the array of alternating tubes 30 and fins 32. Each side plate 34 may be adjacent to the last set of fins 32 forming the array of alternating tubes 30 and fins 32 (as illustrated in FIG. 1) or may be adjacent to the last tube 30 forming the array of alternating tubes 30 and fins 32. The side plates 34 may extend between the first and second headers 22 and may be secured to the first and second headers 22 by a brazing or welding process.

The heat exchanger 20 and header 22 depicted in FIGS. 1 and 2 are not meant to be limiting. For example, the first header tank 24 and the second header tank 26 are shown to include a single chamber for storing a heat transferring fluid. However, other embodiments that include divider walls within the first header tank 24 and the second header tank 26 that divide the single chamber of the respective tanks into multiple chambers should be construed as disclosed herein. As another example, the header 22 is depicted to define a single row of orifices 28. However, other embodiments where the header 22 defines multiple rows and/or columns of orifices 28 should be construed as disclosed herein. The heat exchanger 20 may be utilized in any system that requires a transfer of heat from a first fluid to a second fluid. For example, the exchanger 20 may be utilized as a radiator or a heater core in an engine cooling system of an automobile. As another example, the heat exchanger may be utilized as an evaporator or as a condenser in an air conditioning system.

Heat exchangers are produced one at a time via brazing process within a brazing furnace (i.e., the subcomponents of the heat exchangers are connected to each other via brazing within the brazing furnace). The process may be slow, which increases cycle time and reduces production output. The method described herein includes a process for brazing multiple heat exchangers simultaneously within a brazing furnace, which reduces cycle time and decreases cost.

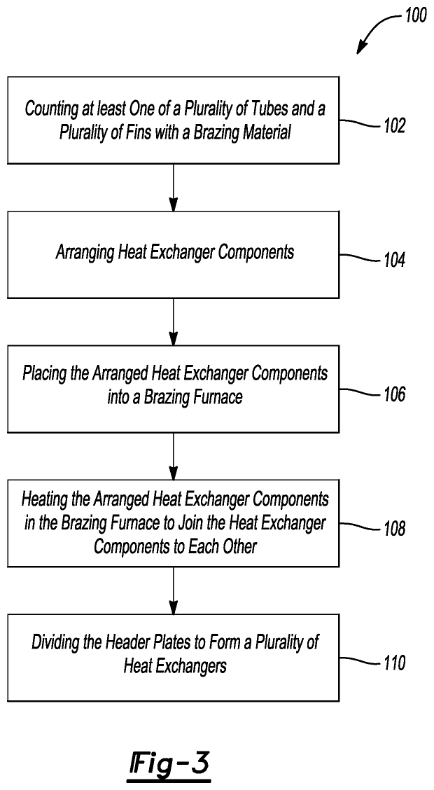

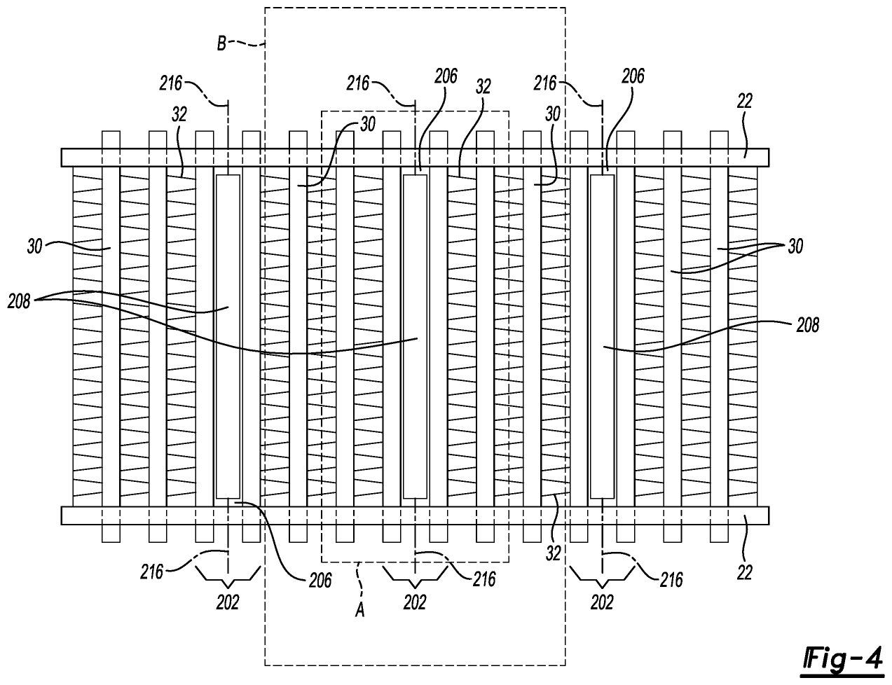

Referring to FIGS. 3-8, a flowchart of method 100 for manufacturing a plurality of heat exchangers is illustrated in FIG. 3 while various heat exchanger subcomponents and spacing systems are illustrated in FIGS. 4-8. It should be noted that the elements in FIGS. 4-8 that are common to the heat exchanger 20 illustrated in FIGS. 1-2 will have the same call out numbers as the common elements in FIGS. 1-2 unless otherwise state herein.

The method 100 begins at block 102 where at least one of a plurality of fins 32 and a plurality of tubes 30 are coated with a brazing material in order to join the tubes 30 and fins 32 to each other once heated. At least one of the headers 22 and the tubes 30 is also coated with a brazing material in order to join the headers 22 and tubes 30 to each other once heated. More specifically, the heat exchanger subcomponents (e.g., the headers 22, tubes 30, and fins 32 illustrated in FIG. 4) that include the brazing material may be clad with the brazing material. The brazing material is configured to adjoin adjacent heat exchanger subcomponents (e.g., the headers 22, tubes 30, and fins 32) to each other when the brazing material is heated to its melting point and then cooled and solidified, which joins the adjacent heat exchanger subcomponents to each other. The heat exchanger subcomponents (e.g., the headers 22, tubes 30, and fins 32) may be aluminum while the brazing material may be an aluminum silicone composite.

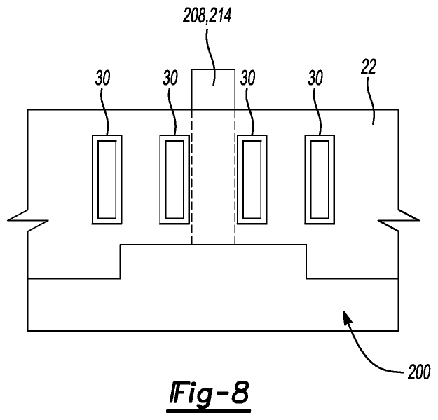

Next, the method 100 moves on to block 104 where the heat exchanger subcomponents (e.g., the headers 22, tubes 30, and fins 32 illustrated in FIG. 4) are arranged relative to each other. Also, at block 104 the heat exchanger subcomponents may be arranged and supported on a fixture 200 (See FIG. 8) that secures a desired position of each of the heat exchanger subcomponents, particularly during a brazing process. The plurality of tubes 30 are secured to and disposed between first and second header plates 22 such that each tube 30 extends into one of a plurality of orifices 28 defined by the first header plate 22 at a first end, such that each tube 30 extends into one of a plurality of orifices 28 defined by the second header plate 22 at a second end, and such that each tube 30 is spaced apart from adjacent tubes 30 (i.e., such that a space is defined between adjacent tubes 30).

A portion of the plurality of fins 32 are disposed between adjacent tubes 30 tubes other than one or more pairs of preselected adjacent tubes 202 of the plurality of tubes 30. If there is only one pair of preselected adjacent tubes 202, the pair of preselected adjacent tubes 202 may be centered such that an equal number of tubes 30 and fins 32 are disposed on each side of the pair of preselected adjacent tubes 202 (e.g., such a configuration would be represented by area B in FIG. 4). If there are more than one pair of preselected adjacent tubes 202, the pairs of preselected adjacent tubes 202 may be equidistantly spaced apart (i.e., there may be an equal number of tubes 30 and fins 32 between each of the pairs of preselected adjacent tubes 202). A spacer 208 may be disposed within the space 206 defined between the tubes 30 in each pair of the one or more pairs of preselected adjacent tubes 202. The spacer 208 may provide structural integrity to the arrangement while the brazing process is occurring (See the step in block 108 below). Such an arrangement of the heat exchanger subcomponents is illustrated in FIG. 4.

If the heat exchanger subcomponents are arranged on the fixture 200, the arrangement will be the same as illustrated in FIG. 4 (i.e., the first and second header plates 22, the plurality of tubes 30, the plurality of fins 32, and the spacers 208 will be arranged on and secured to the fixture 200 such that each tube 30 is spaced apart from adjacent tubes, and such that a portion of the plurality of fins 32 is disposed within each space 206 defined between adjacent tubes 30 other than the preselected pairs adjacent tubes 202 of the plurality of tubes 30).

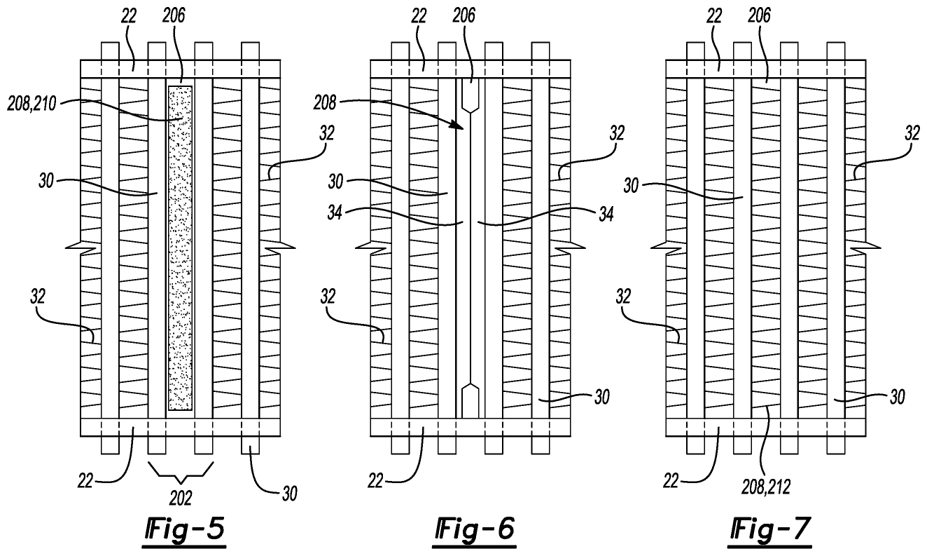

The spacers 208 may comprise a rod or bar that is made from a material that is non-reactive with the brazing material. Such an unreactive rod or bar may be a carbon bar or rod 210, which is illustrated in FIG. 5. Alternatively, the spacers 208 may be a pair of side plates 34, which is illustrated in FIG. 6. Each side plate 34 may be configured form an end of a different heat exchanger. Each side plate 34 may be secured to the first header plate 22 at a first end and may secured to the second header plate 22 at a second end. In another alternative, the spacers 208 may be fins 212 that are not coated with the brazing material, which is illustrated in FIG. 7. The configuration in FIG. 7 may include only coating the remainder of the plurality of fins 32 (i.e., the fins 32 other than the fins 212 operating as the spacers 208) with the brazing material and not coating the plurality of tubes 30 with the brazing material. In yet another alternative, the spacers 208 may be a portion of the fixture 200 such as protrusions 214 that extend into the spaces 206 between the pairs of preselected adjacent tubes 202.

Next, the method 100 moves on to block 106 where the heat exchanger subcomponents (e.g., the headers 22, tubes 30, and fins 32), spacers 208, and fixture 200 (if being utilized) are placed into a brazing furnace. Next, the heat exchanger subcomponents (e.g., the headers 22, tubes 30, and fins 32), spacers 208, and fixture 200 (if being utilized) are all heated within the brazing furnace at block 108 in order to melt the brazing material in order to join the adjacent heat exchanger subcomponents (e.g., the headers 22, tubes 30, and fins 32) to each other, which occurs once the brazing material solidifies after being melted within the furnace. The solidified brazing material forms connections between the adjacent heat exchanger subcomponents. More specifically, the brazing material may join the tubes 30 to the headers 20 and may join the fins 32 to the tube 30 at block 108. The fins 32 may also be joined to the headers 22 along the ends of the fins 32 at block 108. The method 100 next moves on to block 110 where each of the first and second header plates 22 are divided along cut lines 216 (See FIG. 4) between the tubes 30 of each pair of the one or more pairs of preselected adjacent tubes 202 in order to form a plurality of heat exchangers. The spacers 208 may be removed before the step in block 110 occurs. The headers 22 may be divided by a sawing process, a cutting process, a torching process, a severing process, or any other process that is configured sub-divide the headers 22.

It should be noted that the number of tubes 30 and fins 32 of each heat exchanger formed by the process in FIG. 3 is not limited to the number of tubes 30 and fins 32 that is disposed between each spacer 208 as illustrated in FIG. 4. The number of tubes 30 and fins 32 between each spacer 208 may be more than or less than what is illustrated in FIG. 4. Furthermore, the number of tubes 30 and fins 32 between each spacer 208 may be same as illustrated in FIG. 4 in order form heat exchangers of the same size (i.e., heat exchangers having the same numbers of tubes 30 and fins 32), or the number of tubes 30 and fins 32 between each spacer 208 may be different in order form heat exchangers of the different sizes (i.e., heat exchangers having the different numbers of tubes 30 and fins 32).

It should be understood that the flowchart in FIG. 3 is for illustrative purposes only and that the method 100 should not be construed as limited to the flowchart in FIG. 3. Some of the steps of the method 100 may be rearranged while others may be omitted entirely. It should further be understood that the designations of first, second, third, fourth, etc. for any component, state, or condition described herein may be rearranged in the claims so that they are in chronological order with respect to the claims.

The words used in the specification are words of description rather than limitation, and it is understood that various changes may be made without departing from the spirit and scope of the disclosure. As previously described, the features of various embodiments may be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

What is claimed is:

1. A method for manufacturing heat exchangers comprising:
coating at least one of a plurality of fins and a plurality of tubes with a brazing material;
disposing the plurality of tubes between first and second header plates such that each tube extends into one of a plurality of orifices defined by the first header plate at a first end and such that each tube extends into one of a plurality of orifices defined by the second header plate at a second end;
disposing a portion of the plurality of fins between adjacent tubes of the plurality of tubes other than one or more pairs of preselected adjacent tubes of the plurality of tubes;
disposing a spacer between the tubes in each pair of the one or more pairs of preselected adjacent tubes;
placing the first and second header plates, the plurality of tubes, the plurality of fins, and the spacer into a brazing furnace;
heating the first and second header plates, the plurality of tubes, the plurality of fins, and the spacer in the brazing furnace such that the brazing material joins the plurality of fins to the plurality of tubes; and
dividing each of the first and second header plates between the tubes of each pair of the one or more pairs of preselected adjacent tubes to form a plurality of heat exchangers.

2. The method of claim 1, wherein the one or more pairs of preselected adjacent tubes of the plurality of tubes are equidistantly spaced apart.

3. The method of claim 1, wherein the spacer disposed between the tubes in each pair of the one or more pairs of preselected adjacent tubes is an unreactive bar.

4. The method of claim 1, wherein the spacer disposed between the tubes in each pair of the one or more pairs of preselected adjacent tubes is a portion of a fixture that supports the first and second header plates, the plurality of tubes, and the plurality of fins within the brazing furnace.

5. The method of claim 1, wherein only the plurality of fins is coated with the brazing material.

6. The method of claim 5, wherein the spacer disposed between the tubes in each pair of the one or more pairs of preselected adjacent tubes is a fin that is not coated with the brazing material.

7. The method of claim 1, wherein the spacer disposed between the tubes in each pair of the one or more pairs of preselected adjacent tubes is a pair of side plates.

8. The method of claim 7, wherein each of the pair of side plates is secured to the first header plate at a first end and is secured to the second header plate at a second end.

9. A method for manufacturing heat exchangers comprising:
securing a plurality of tubes to first and second header plates such that each tube extends between the first and second header plates and such that each tube is spaced apart from adjacent tubes;
disposing a portion of a plurality of fins between adjacent tubes of the plurality of tubes other than a preselected pair adjacent tubes of the plurality of tubes;
disposing a spacer between the tubes of the preselected pair adjacent tubes;
heating the first and second header plates, the plurality of tubes, the plurality of fins, and the spacer in a brazing furnace such that a brazing material joins the plurality of fins to the plurality of tubes; and
dividing each of the first and second header plates between the tubes of the preselected pair of adjacent tubes to form two heat exchangers.

10. The method of claim 9, wherein the preselected pair of adjacent tubes is positioned at a center of the plurality of tubes.

11. The method of claim 9, wherein the spacer disposed between the tubes of the preselected pair of adjacent tubes is an unreactive bar.

12. The method of claim 9, wherein the spacer disposed between the tubes of the preselected pair of adjacent tubes is a portion of a fixture that supports the first and second header plates, the plurality of tubes, and the plurality of fins within the brazing furnace.

13. The method of claim 9, wherein the spacer disposed between the tubes of the preselected pair of adjacent tubes is a fin that is not coated with the brazing material.

14. The method of claim 9, wherein the spacer disposed between the tubes of the preselected pair of adjacent tubes is a pair of side plates.

15. The method of claim 14, wherein each of the pair of side plates is secured to the first header plate at a first end and is secured to the second header plate at a second end.

16. A method for manufacturing heat exchangers comprising:
securing first and second header plates, a plurality of tubes, and a plurality of fins to a fixture such that each tube is spaced apart from adjacent tubes, and such that a portion of the plurality of fins is disposed within spaces defined between adjacent tubes other than a preselected pair adjacent tubes of the plurality of tubes;
disposing a spacer between the tubes of the preselected pair adjacent tubes;
heating the first and second header plates, the plurality of tubes, the plurality of fins, and the spacer in a brazing furnace such that a brazing material joins the plurality of fins to the plurality of tubes; and
dividing each of the first and second header plates along the space defined between the tubes of the preselected pair of adjacent tubes to form a pair of heat exchangers.

17. The method of claim 16, wherein the spacer disposed between the tubes of the preselected pair of adjacent tubes is an unreactive bar.

18. The method of claim 16, wherein the spacer disposed between the tubes of the preselected pair of adjacent tubes is a portion of the fixture.

19. The method of claim 16, wherein the spacer disposed between the tubes of the preselected pair of adjacent tubes is a fin that is not coated with the brazing material.

20. The method of claim 16, wherein the spacer disposed between the tubes of the preselected pair of adjacent tubes is a pair of side plates.
